(19) United States
(12) Patent Application Publication
(10) Pub. No.: US 2003/0107604 A1
(43) Pub. Date: Jun. 12, 2003

(54) Method and system for automatic window resizing in a graphical user interface

(76) Inventor: Bas Ording, Sunnyvale, CA (US)

Correspondence Address: James W. Peterson, BURNS, DOANE, SWECKER & MATHIS, L.L.P., P.O. Box 1404, Alexandria, VA, 22313-1404, US

(21) Appl. No.: 10/012,284

(22) Filed: Dec. 12, 2001

(51) Int. Cl. G09G 5/00

(52) U.S. Cl. 345/788

(57) ABSTRACT

A method and system is described for automatically resizing a window displayed within a display area in a graphical user interface environment. Exemplary embodiments of the present invention detect that at least a portion of the window is being dragged between a region inside of the display area and a region outside of the display area. Upon detection, the window is resized while being dragged. The resized window can be redrawn so that the frame of the resized window is displayed in the region inside of the display area.

### BACKGROUND

1. Field of the Invention

The present invention relates to graphical user interfaces for computer systems. More particularly, the present invention relates to a method and system for automatic resizing of windows displayed within a graphical user interface environment.

2. Background Information

common technique for presenting information to operators of computer-based systems is a graphical user interface (GUI). A GUI is a program interface that takes advantage of a computer's graphics capabilities to allow the user to interact with the computer through visual components, as opposed to a command-driven interface in which a user interacts with the computer entirely through text-based commands. A GUI is typically part of an environment provided by an operating system executed by a processor in the computer system. Generally, the GUI is controlled by the operating system, or a window manager running in the operating system, in response to commands provided by a user and application programs or other processes executing on or accessible to the computer-based system.

Common to virtually all conventional GUIs is the use of a computer mouse or other computer pointing device in a windowed environment. Windows are generally rectangular areas presented on a display that contain textual and/or graphical information related to the operation of the application program, operating system or other processes. Generally, additional display elements are provided by the GUI to facilitate interactions with the windows. These display elements include, for example, menus, title bars, buttons, select boxes and icons.

In this environment, the user interacts with the computer by manipulating the cursor displayed on the GUI with a computer pointing device. To enter information into the computer system, a user typically interacts with one or more displayed windows. The position and dimensions of the windows are configurable by the user. A user can move, resize, open and close windows at will.

Since the dimensions of a window can be changed by a user, it is possible that a window can be configured in such a way that the size of the window is not large enough to display the entire contents of the window. To facilitate the display of information in the window in such an instance, a window typically includes scrollbars to allow the user to access information in parts of the window which are not viewable by the user. The scrollbar generally appears on the side or bottom of a window to control which part of a document is currently in the window's frame. As used herein, a document is any collection of data that can be viewed within a window by a user, such as, for example, a text file, an image, a list of files, or any other collection of data. As used herein, a pane is the amount of the document that is visible within a window's frame at one time. A scrollbar is used to view different portions of the document if the size of the document is greater than the size of the pane.

The scrollbar consists of a strip along one edge of the window, called the scroll region or scroll channel, representing the full range of the scroll. It has a smaller element, called the scroll box (also called a slider or elevator), within the scroll region, representing the position of the document relative to the full scroll. In some GUIs, the size of the scroll box is the proportion of the document that is currently visible—the size of the scroll box relative to the length of the scroll region is equivalent to the size of the pane relative to the size of the document. For example, if the scroll box occupies one-third of the length of the scroll region, then two-thirds of the document's contents are not displayed. Conversely, if the scroll box occupies two-thirds of the length of the scroll region, then one-third of the document's contents are not displayed. If the entire document is visible, the scroll box may fill the entire scroll region or the scrollbar(s) may not be displayed at all.

The scrollbar usually has arrow graphics (commonly referred to as scroll arrows) at one or both ends of the scroll region. By clicking on an arrow, the user moves the scroll box one small increment (e.g., one line of text) in the direction of the arrow. By clicking in the scroll region between an arrow and the scroll box, the user moves the scroll box a larger increment (the page increment) in the direction of the arrow. The user can also drag the scroll box using the mouse.

In a GUI environment, the view space represents the entire area in which windows and other elements of the GUI can be located. The display space or display area is that portion of the view space that is actually displayed to a user through one or more computer monitors or other display devices. The view space is typically larger than the display area which is displayed on one or more monitors. As a result, a user can position a window within the view space such that only a portion of the window is located within the display area.

In conventional GUIs, when a user either intentionally or accidentally moves a portion of a window outside of the display area, e.g., outside the borders of a computer monitor, only a portion of the window is viewable by the user. The portion of the window which lies outside the display area can be neither viewed nor accessed by the user. This poses a particular problem to a user if the inaccessible portion of the window contains the scrollbar(s) or other control elements, such as, for example, close box, resize box, etc., necessary to access or control the contents of the rest of the window. To view the obscured contents of the window or to operate the scrollbar(s) or other control elements that are out of reach, the user must move the entire window completely back into the display area. Alternatively, if a user attempts to rearrange windows on a screen to prevent windows from overlapping one another, but desires to maintain access to each window's control elements, the user must manually reduce the size of one or more of the windows to keep the windows within the display area. Such a restriction diminishes a user's flexibility in arranging the display area within the GUI environment.

It is desirable to provide a method and system by which a user can drag a window at least partially outside of a display area and still be able to access the entire contents and control elements of the window without having to drag the entire window back into the display area.

### SUMMARY OF THE INVENTION

A method and system is described for automatically resizing a window displayed within a display area in a graphical user interface environment. Exemplary embodiments of the present invention detect that at least a portion of the window is being dragged between a region inside of the display area and a region outside of the display area. Upon detection, the window is resized while being dragged. The resized window can be redrawn so that the frame of the resized window is displayed in the region inside of the display area.

### BRIEF DESCRIPTION OF THE DRAWING FIGURES

Other objects and advantages of the present invention will become apparent to those skilled in the art upon reading the following detailed description of preferred embodiments, in conjunction with the accompanying drawings, wherein like reference numerals have been used to designate like elements, and wherein:

FIG. 1 is a block diagram illustrating a system for automatically resizing a window displayed within a display area in a graphical user interface (GUI) environment in accordance with an exemplary embodiment of the present invention;

FIG. 2 is a graphical presentation of a window in a GUI environment at the window's original size;

FIG. 3 is a graphical presentation of a window in a GUI environment at the window's original size;

FIG. 4 is a graphical presentation of the window in a GUI environment being dragged partially outside of the display area;

FIG. 5 is a graphical presentation of the window in a GUI environment with scrollbars within the display area and the window resized in accordance with exemplary embodiments of the present invention;

FIG. 6 is a flowchart illustrating the steps carried out for automatically resizing a window displayed within a display area in a graphical user interface (GUI) environment in accordance with an exemplary embodiment of the present invention;

FIG. 7 is a flowchart illustrating the steps carried out for resizing the window in accordance with an exemplary embodiment of the present invention; and

FIG. 8 is a flowchart illustrating the steps carried out for restoring a window to its stored current size in accordance with exemplary embodiments of the present invention.

### DETAILED DESCRIPTION OF THE PREFERRED EMBODIMENTS

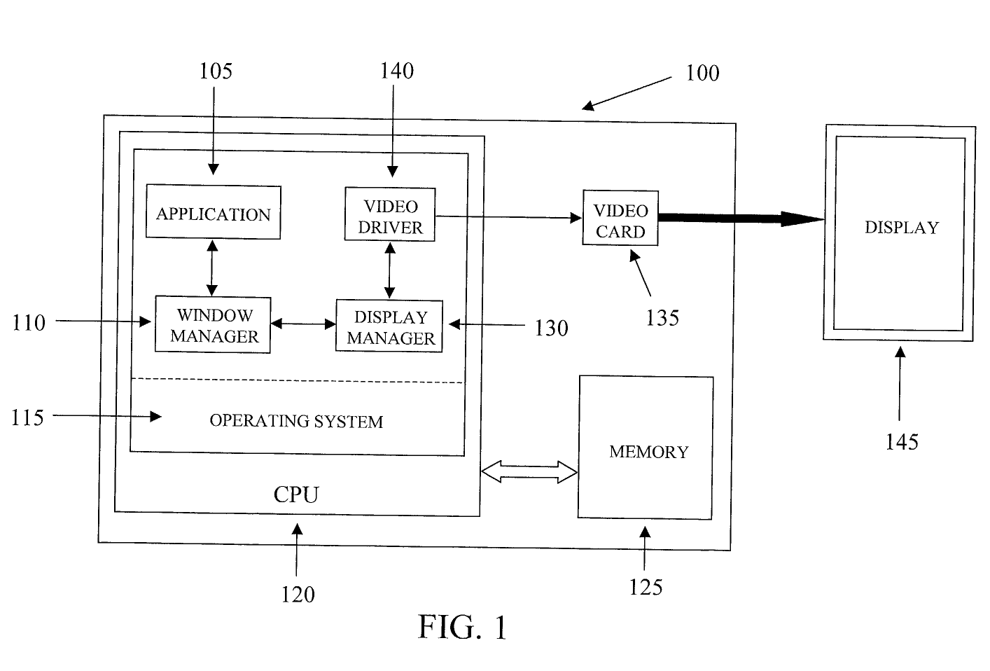

FIG. 1 is a block diagram illustrating a system for automatically resizing a window displayed within a display area in a graphical user interface (GUI) environment in accordance with an exemplary embodiment of the present invention. The system of FIG. 1 includes a computer 100 that can be any type of computer, such as, for example, a personal computer, a workstation, a minicomputer, a supercomputer, or any other type of computer that can support a GUI environment. Computer 100 includes a central processing unit (CPU) 120. CPU 120 can be any form of processor, such as, for example, a microprocessor. Computer 100 also includes a memory 125. Memory 125 can be any form of computer memory, such as, for example, random access memory (RAM), or any other form of computer memory. Software components of computer 100 can be stored in any form of electronic storage medium, such as, for example, a computer hard disk, and loaded into memory 125 for execution by CPU 120. The system illustrated in FIG. 1 includes at least one display 145. Display 145 can be any type of computer display, such as, for example, a computer monitor, LCD screen, plasma display, or any other form of computer display on which graphical and/or textual data can be presented to a user. Each display 145 is connected to, and controlled by, a video card 135 that operates in accordance with video driver software 140.

An operating system 115 running on CPU 120 can include a window manager 110. Operating system 115 can be any type of computer operating system that supports a GUI environment. Window manager 110 manages graphical windows and other graphical and/or textual control elements displayed on display 145. For example, window manager 110 can keep track of the location, size and status of each graphical window displayed on display 145. Window manager 110 can be any type of window manager or any other type of application that can manage graphical windows through which documents and any other form of graphical and/or textual information can be displayed to a user on a display device (e.g., display 145). Operating system 115 can also include a display manager 130 that provides communication between window manager 110 and the display devices (e.g., display 145) via the display devices'associated video driver software 140 and video card 135. Display manager 130 can be a software component that is either separate from or an integrated component of window manager 110.

At least one software program, such as application program 105, generates information to be displayed on the display devices (e.g., display 145). Examples of such information include text, windows and other graphical objects, and control structures, such as, for example, menus and dialog boxes. This information is presented to display manager 130 through window manager 110 for eventual display to a user on display 145.

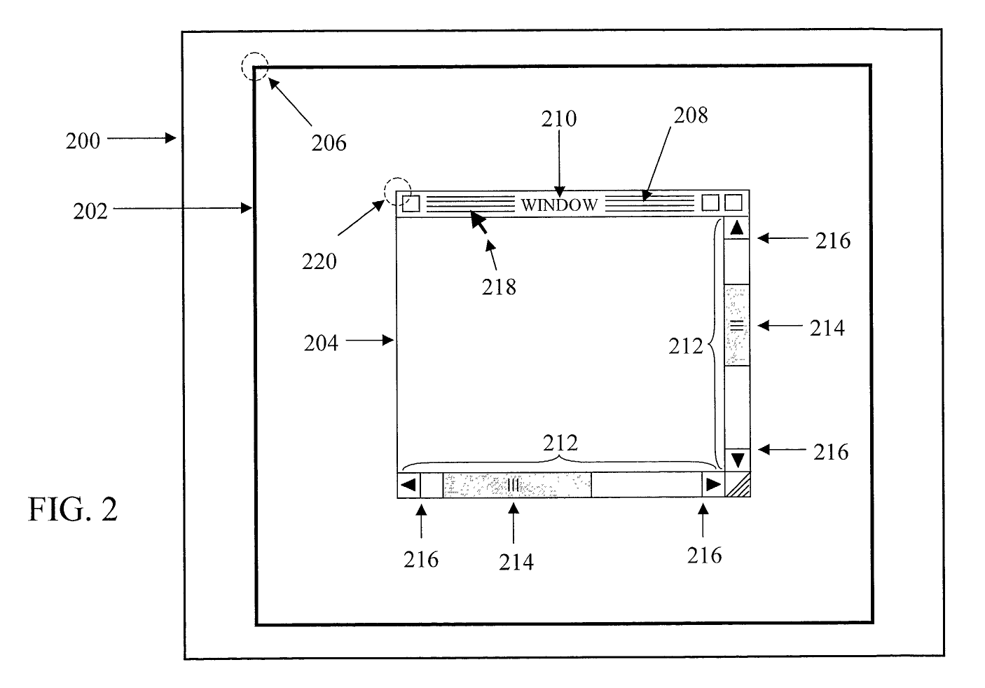

As illustrated in FIG. 2, a display environment of the system of FIG. 1 can include a view space 200, which is the entire area managed by the display manager 130. Objects and other information to be displayed can be positioned anywhere within view space 200, as determined by the user and/or the software program that generates the information. In the example illustrated in FIG. 2, view space 200 consists of a display area 202. Display area 202 is that portion of view space 200 that is actually displayed to a user through one or more computer monitors or other display devices (e.g., display 145). As illustrated in FIG. 2, display area 202 can display one or more graphical windows, such as window 204.

As shown in FIG. 2, a reference point in display area 202, e.g., its origin or the (0,0) coordinate point, is usually established with reference to some object that is always present in display area 202. For example, most GUIs include some type of menu bar or other structure that enables the user to access basic commands to control the computer. The device that displays this menu bar is known as the main display device. If the computer system contains multiple display devices, only one of the devices is designated as the main device, even if multiple devices contain the menu bar. The origin of the coordinate display area can be established, for example, with reference to the menu bar or any other fixed location in display area 202 of view space 200.

As illustrated in FIG. 2, display area reference point 206 in the coordinate space of display area 202 can coincide with the top left corner of display area 202. Display area reference point 206 can be the (0,0) origin of display area 202 or any other reference point (X_{O}, Y_{O}) in display area 202. The position of all objects and other information to be displayed in display area 202 are defined by their coordinates within this space relative to display area reference point 206. For example, the position of window 204 can be defined by the coordinates of window origin 220 relative to display area reference point 206. Window manager 110 receives this coordinate information, for example, from application program 105, and provides it to display manager 130 to cause the information to appear at the appropriate place on the screen of display 145 located at the corresponding position in display area 202.

As shown in FIG. 2, window 204 has a window frame which borders window 204. The window frame can be comprised of, for example, a title bar 208 containing a title 210. In addition, if the size of the document displayed in window 204 is greater than the size of the window, the window frame can include at least one scrollbar 212. Within scrollbar 212, scroll box 214 can be used to control which part of the document is currently in the window's view. Scroll arrows 216 can be used to move scroll box 214 and scroll the document displayed within window 204. By using a pointer device, such as, for example, a computer mouse or any other computer pointer device, a user can select and move the window frame by, for example, placing cursor 218 on title bar 208 and clicking, holding, and dragging window 204. A user can move or drag window 204 anywhere within the region inside of display area 202.

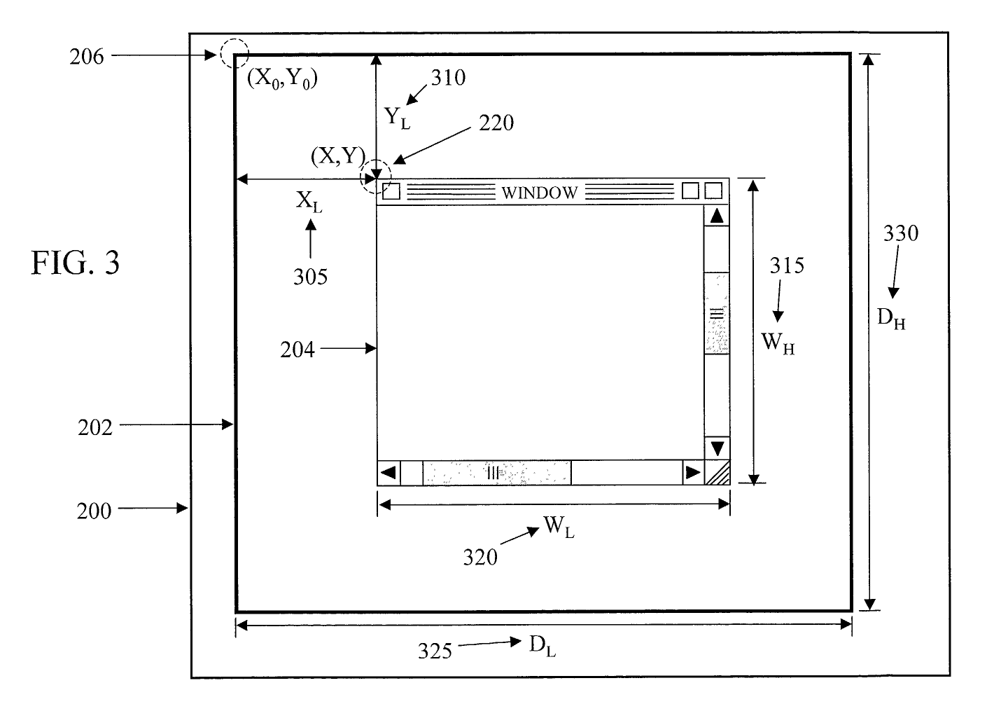

As shown in FIG. 3, according to an exemplary embodiment of the present invention, window manager 110 can maintain or otherwise store several pieces of information about display area 202 and the graphical objects displayed within display area 202. For example, window manager 110 can store the dimensions of display area 202, such as, for example, the length of display area 202 (e.g., display area length 325 (D_{L})) and the height of display area 202 (e.g., display area height 330 (D_{H})). Window manager 110 can also store the current dimensions of window 204, such as, for example, the length of window 204 (e.g., window length 320 (W_{L})) and the height of window 204 (e.g., window height 315 (W_{H})), or any other type of information that represents the current size of window 204. Window manager 110 can also store a coordinate tuple for window 204, or any other form of information which indicates the position of window 204 relative to display area 202. For example, the coordinate tuple of window 204 can include the coordinates of window origin 220, the X-coordinate displacement 305 (X_{L}) of window origin 220, and the Y-coordinate displacement 310 (Y_{L}) of window origin 220. Both X-coordinate displacement 305 and Y-coordinate displacement 310 can be calculated relative to display area reference point 206.

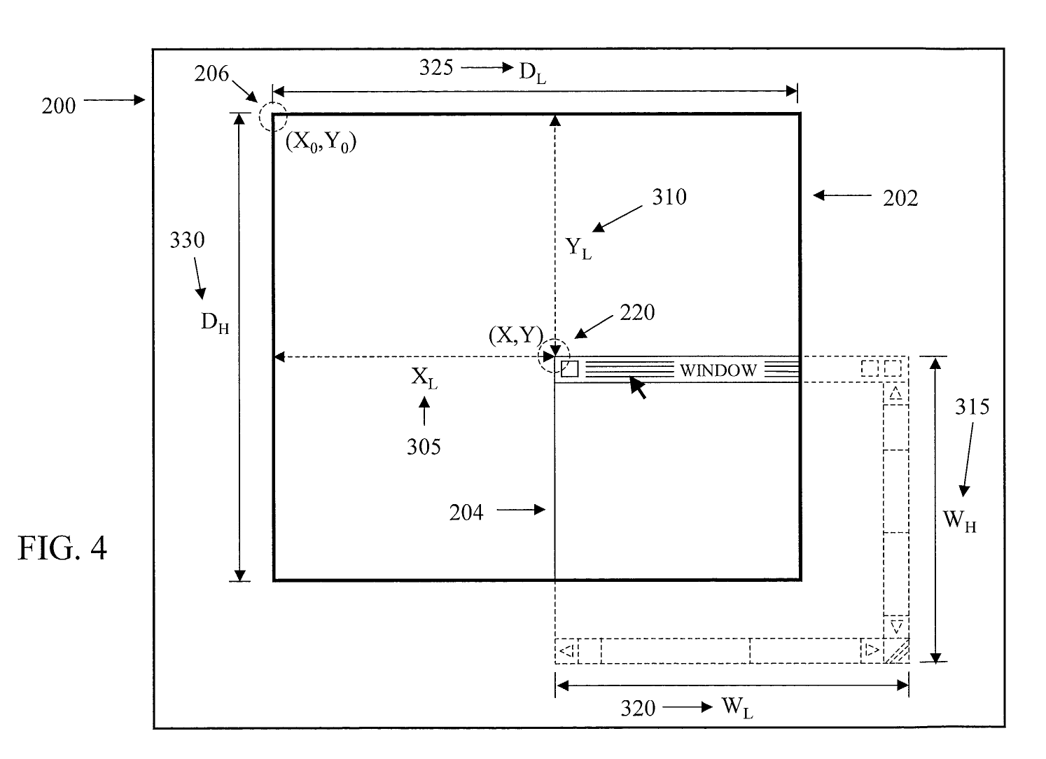

As shown in FIG. 4, a user can move or drag at least a portion of window 204 to a region outside of display area 202. In FIG. 4, although still within view space 200 of which display area 202 is a part, a portion of window 204 lies in a region outside of display area 202 and, therefore, cannot be seen by a user. According to exemplary embodiments of the present invention, window manager 110 detects that at least a portion of window 204 is being dragged between a region inside of display area 202 and a region outside of display area 202. The window manager can determine coordinates of the display area and determine the coordinates of the window and use the window coordinates and display area coordinates to calculate the portion of the window that is located in the region outside of the display area.

As shown in FIG. 4, as the user moves window 204, X-coordinate displacement 305 and Y-coordinate displacement 310 change in magnitude. In the example shown in FIG. 4, both X-coordinate displacement 305 and Y-coordinate displacement 310 are increasing. According to exemplary embodiments, any or all of window 204 is located outside of display area 202 if any or any combination of the following conditions are satisfied:

1.) the X-coordinate of window origin 220 is less than the X-coordinate of display area reference point 206: X<X_{O};

2.) the Y-coordinate of window origin 220 is less than the Y-coordinate of display area reference point 206: Y<Y_{O};

3.) the sum of X-coordinate length 305 of window origin 220 and window length 320 of window 204 is greater than display area length 325 of display area 202: X_{L}+W_{L}>D_{L}; or

4.) the sum of Y-coordinate displacement 310 of window origin 220 and window height 315 of window 204 is greater than display height 330 of display area 202: Y_{L}+W_{H}>D_{H}.

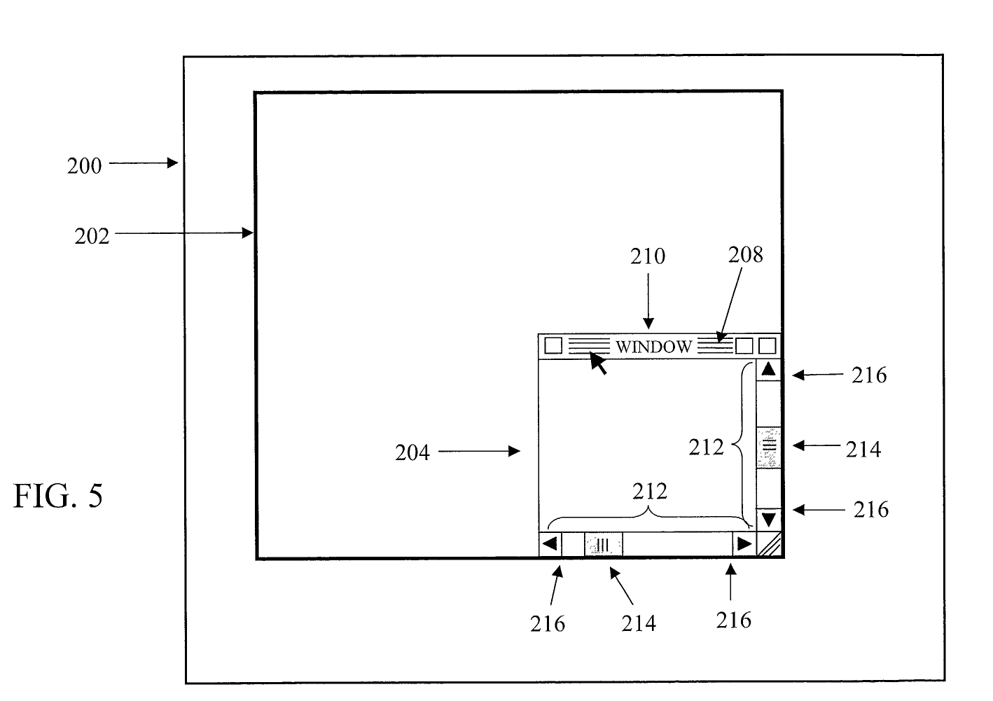

Thus, window manager 110 determines whether a border of window 204 crosses a border of display area 202 when detecting that window 204 is being dragged. If any of conditions (1)-(4) is satisfied, window manager 110 resizes window 204 while window 204 is being dragged. As shown in FIG. 5, window manager 110 subtracts from window 204 the portion of window 204 that is located in the region outside of display area 202. Thus, in the examples of FIGS. 4 and 5, window manager 110 reduces the values for W_{L} and W_{H} so that W_{L}=D_{L}−X_{L} and W_{H}=D_{H}−X_{H}, respectively. Window manager 110 then redraws resized window 204 so that the frame of resized window 204 is displayed in the region inside of display area 202. Window manager 110 also redraws elements of window 204 while window 204 is being dragged so that the elements are displayed in the region inside of display area 202. For example, as shown in FIG. 5, window manager 110 redraws title bar 208, title 210, scrollbars 212, scroll arrows 216, and scroll boxes 214. Since window 204 has been resized, scroll boxes 214 have been drawn proportional to a ratio of the size of the resized window to the size of the document displayed in window 204.

In FIGS. 2-5, display area 202 is illustrated as encompassing the entire screen of the computer monitor or display device on which display area 202 is displayed to a user. However, the available display area 202 for window displacement can be any subset of the portion of view space 200 that is actually displayed to a user through one or more computer monitors or other display devices. Display area 202 can be defined by one or more objects that create any form of edge or boundary that delimits a display area. For example, an application palette or dock, a second window or region, or any other type of object that cannot be obscured by windows and, therefore, creates an edge or boundary can be used to define the display area. Thus, if window 204 is dragged beyond the specified edge or boundary, automatic window resizing in accordance with exemplary embodiments of the present invention will occur.

As window manager 110 resizes and redraws window 204, window manager 110 notifies applications using window 204 that the window is being resized. Consequently, either the application using window 204 or window manager 110 can also redraw the document displayed in window 204 so that the contents, or any portion thereof, are displayed in the region inside of display area 202.

In the examples of FIGS. 4 and 5, window 204 is reduced in size as the window is moved to a region outside of display area 202. Conversely, as the user moves or otherwise drags window 204 back into the region inside display area 202, a similar resizing process occurs to increase the size of the window while window 204 is being dragged. Preferably, window manager 1 10 stores the original size of window 204, and restores window 204 to its stored original size after window 204 is dragged entirely back within the inside region of display area 202.

According to exemplary embodiments, a preference item can be selected by the user so that, when window 204 is being dragged to the region outside of display area 202, the resized window will have at least a predetermined minimum size. In one exemplary embodiment, the size of displayed window 204 will not be smaller than this predetermined minimum size, regardless of how close the user drags the cursor towards the edge of display area 202. In other words, with reference to FIG. 5, as the user continues to move the cursor to the right and/or downward, the window will remain within the display area as shown, at its minimum size. According to an alternate exemplary embodiment, once resized window 204 reaches its predetermined minimum size, the predetermined-minimum resized window acts like a regular window without automatic resizing. Thus, according to this alternate exemplary embodiment, the user can drag the predetermined-minimum resized window outside of display area 202, resulting in portions of the predetermined-minimum resized window being obscured.

According to another alternate exemplary embodiment, the automatic window resizing can be selectively inhibited for the GUI environment, for instance, by means of another user preference item. Accordingly, if the automatic window resizing is disabled or otherwise inhibited, window manager 110 will not automatically resize window 204 as it is being dragged to the region outside of display area 202.

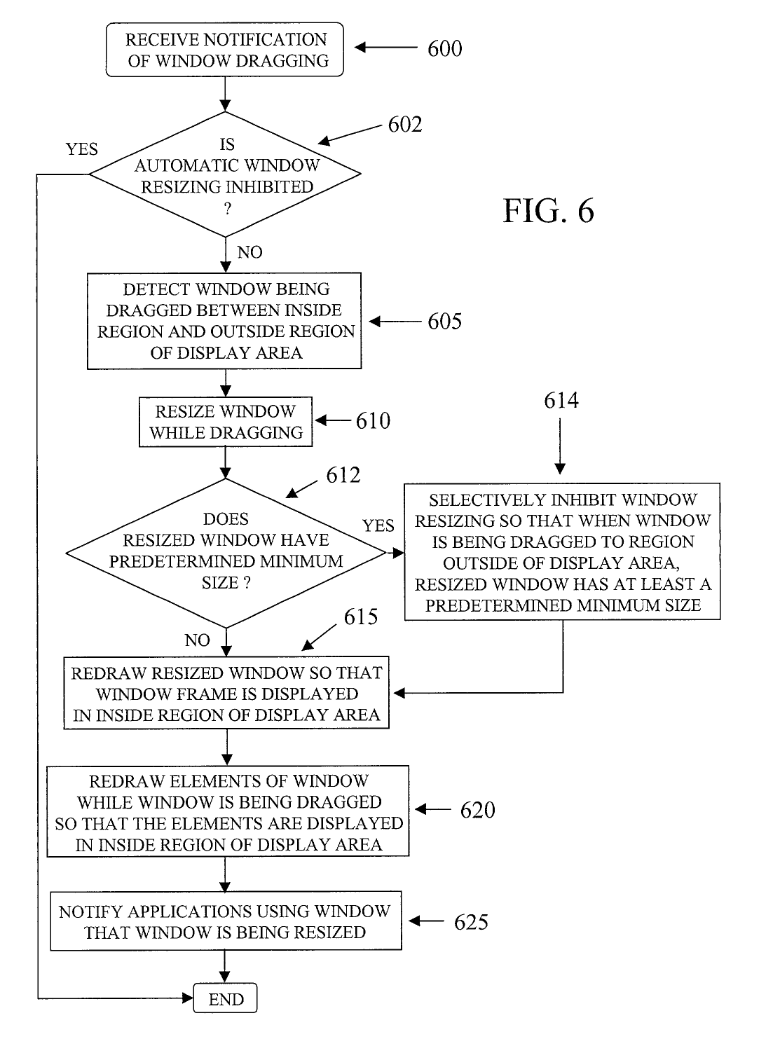

FIG. 6 is a flowchart illustrating the steps carried out for automatically resizing a window displayed within a display area in a graphical user interface (GUI) environment in accordance with an exemplary embodiment of the present invention. According to exemplary embodiments, the steps illustrated in FIG. 6 can be performed using any type of computer, such as, for example, a personal computer, that has an operating system that supports a GUI environment. The GUI environment can have, for example, an operating system, a window manager, or any other application which can manage graphical windows through which documents are displayed to users.

Automatic window resizing in accordance with exemplary embodiments of the present invention can be selectively inhibited for the GUI environment. The process of FIG. 6 begins at step 600 when the window manager receives a notification that a window is being moved, e.g., the user clicks a mouse while the cursor is positioned on the title bar of the window. In step 602, a determination is made as to whether automatic window resizing is inhibited or otherwise deactivated. If deactivated, no window resizing will occur if a window is dragged at least partially to the region outside of display area 202. Such an exemplary embodiment can allow a user to drag a window entirely off the display area.

However, if it is determined in step 602 that automatic window resizing is enabled, then in step 605, the window manager 110 detects that at least a portion of a window is being dragged between a region inside of a display area and a region outside of the display area. According to exemplary embodiments, detecting step 605 determines when a border of the window crosses a border of the display area. The window manager can determine coordinates of the display area, determine the coordinates of the window, and use the window coordinates and display area coordinates to calculate the portion of the window that is located in the region outside of the display area. For example, as shown in FIG. 4, as the user moves window 204, X-coordinate displacement 305 and Y-coordinate displacement 310 change in magnitude. In the example shown in FIG. 4, both X-coordinate displacement 305 and Y-coordinate displacement 310 are increasing. According to exemplary embodiments, any or all of window 204 is located outside of display area 202 if any of the four conditions described previously are satisfied. If any of these conditions are satisfied, in step 610, the window is resized while it is being dragged.

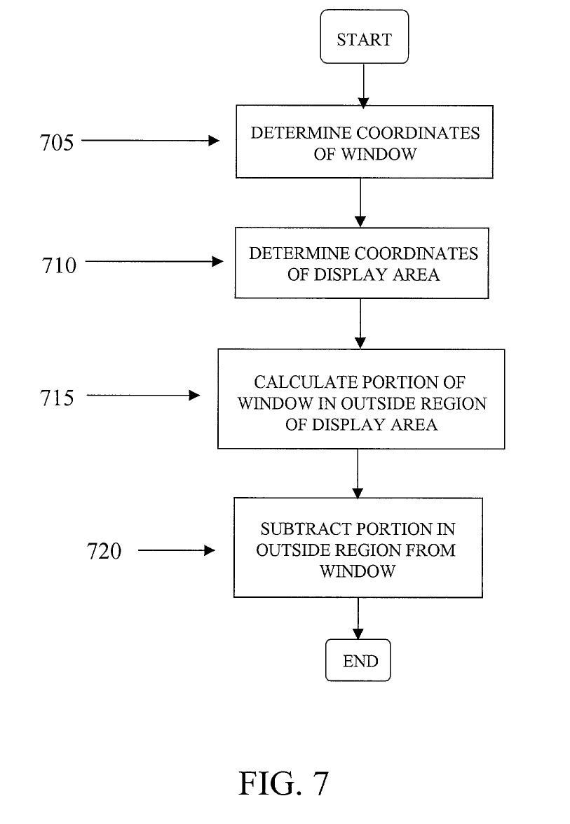

The process of resizing a window while it is being dragged between a region inside of a display area and a region outside of a display area will be described with reference to FIG. 7. In step 705, the coordinates of the window (e.g., window origin 220 of window 204) are determined. The position and size of the window can be determined by referencing, for example, a corner or center of the window relative to, for example, a corner of the display area or any other part of display area or the view space of which the display area is a part. In step 710, the coordinates of the display area (e.g., display area reference point 206 of display area 202) can be determined. The position and size of the display area can be determined relative to, for example, the view space (e.g., view space 200) of which the display area is a part. In step 715, the window coordinates and the display area coordinates can be used to calculate the portion of the window that is located in the region outside of the display area. Referring to FIG. 4, the coordinates of window 204 and the coordinates of display area 202 can be used to calculate the portion of window 204 that is located in the region outside of display area 202. In step 720, the portion of the window that is located in the region outside of the display area can be subtracted from the window. For example, referring to FIG. 4, the portion of window 204 that lies outside of display area 202 can be subtracted from window 204.

It is possible that window 204 can be dragged so far to the region outside of display area 202 that when the window is automatically resized, most or all of the contents of window 204 are no longer visible. To prevent this situation from occurring, in step 612, a determination is made as to whether the resized window has a predetermined minimum size. If so, then in step 614, exemplary embodiments of the present invention selectively inhibit window resizing so that when the window is being dragged to the region outside of the display area, the resized window has at least a predetermined minimum size. The predetermined minimum size can be, for example, specified by the user or fixed by the operating system or window manager.

According to an exemplary embodiment of the present invention, if the size of the resized window 204 in FIG. 5 is set by a user to be the size of the minimum-allowable resized window, then if window 204 is dragged outside of display area 202 beyond that amount, a window of the size of the resized window 204 of FIG. 5 will be redrawn and displayed to the user. According to this exemplary embodiment, the size of resized window 204 will not be smaller than the predetermined minimum size, regardless of how far the cursor is dragged towards the edge of display area 202. According to an alternate exemplary embodiment, once the resized window reaches its predetermined minimum size, the predetermined-minimum resized window acts like a regular window without automatic resizing. Thus, according to this alternate exemplary embodiment, the user can drag the predetermined-minimum resized window outside of display area 202, resulting in portions of the predetermined-minimum resized window being obscured. Such exemplary embodiments can allow at least a minimum amount of content of the window to be displayed to the user when the window is dragged outside the display area by more than the predetermined amount.

In step 615 of FIG. 6, after the window has been resized, the resized window can be redrawn so that a frame of the resized window is displayed in the region inside of the display area. Referring to FIG. 5, window 204 is redrawn as a resized window so that the frame of window 204 appears within the resized window in the region inside of display area 202. According to exemplary embodiments of the present invention, in step 620 of FIG. 6, elements of the resized window can be redrawn while the window is being dragged so that the elements are continuously displayed in the region inside of the display area. Referring to FIG. 5, elements such as, for example, title bar 208, title 210 and the document displayed within window 204 can be redrawn as window 204 is being dragged.

According to exemplary embodiments, in step 625 of FIG. 6, applications using the window (e.g., window 204) can be notified that the window is being resized. Such notification can allow applications using the window or the window manager managing the window to, for example, wrap words and sentences or rearrange files contained in the document according to the size of the resized window. In addition, at least one scrollbar can be redrawn. For example, scrollbars 212 can be redrawn as window 204 is being dragged. As scrollbars 212 are redrawn, scroll boxes 214 can also be redrawn so that they are proportional to a ratio of the size of the resized window (e.g., the pane) to the size of the document. The window manager can continuously loop through the steps of FIG. 6 as long as the user holds the mouse button down, so that the resizing and redrawing occurs dynamically as the window is being dragged.

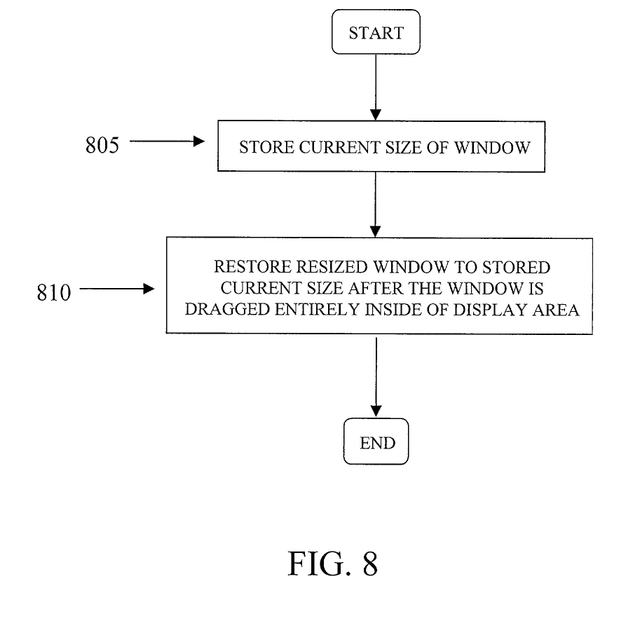

In step 805 of FIG. 8, exemplary embodiments of the present invention can store the current size of the window before it is resized. Storing the window's original size allows the window to be restored to its original, pre-resized dimensions. The window's original size can be stored by, for example, the window manager or any other application that manages or otherwise draws the window. Thus, the original size of window 204 as shown in FIG. 3 can be stored in, for example, computer memory for later retrieval. The window can then be dragged at least partially outside of the display area (e.g., display area 202) and redrawn as a resized window. In step 810 of FIG. 8, after the window is dragged entirely within the inside region of the display area, the resized window can be restored to the stored current size, i.e., W_{L} and W_{H} are reset to their original values. Thus, after resized window 204 is dragged entirely within the region inside display area 202, window 204 can be restored to its original size as shown in FIG. 3 using the stored current size.

The steps of a computer program as illustrated in FIGS. 6-8 for automatically resizing a window displayed within a display area in a graphical user interface environment can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. As used herein, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

It will be appreciated by those of ordinary skill in the art that the present invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

What is claimed is:

1. A method for automatically resizing a window displayed within a display area in a graphical user interface environment, comprising the steps of:
detecting that at least a portion of said window is being dragged between a region inside of said display area and a region outside of said display area; and
resizing said window while said window is being dragged.

2. The method of claim 1, further including the step of:
redrawing said resized window so that a frame of said resized window is displayed in said region inside of said display area.

3. The method of claim 1, wherein the step of resizing comprises the steps of:
determining coordinates of said window;
determining coordinates of said display area;
using said window coordinates and said display area coordinates to calculate said portion of said window that is located in said region outside of said display area; and
subtracting from said window said portion of said window that is located in said region outside of said display area.

4. The method of claim 1, further comprising the steps of:
storing a current size of said window; and
restoring said resized window to said stored current size after said window is dragged entirely in said region inside of said display area.

5. The method of claim 1, wherein said step of detecting determines when a border of said window crosses a border of said display area.

6. The method of claim 1, further including the step of:
selectively inhibiting said resizing step so that when said window is being dragged to said region outside of said display area, said resized window has at least a predetermined minimum size.

7. The method of claim 1, wherein said automatic window resizing can be selectively inhibited for said graphical user interface environment.

8. The method of claim 1, wherein the step of resizing further comprises the step of:
notifying applications using said window that said window is being resized.

9. The method of claim 2, wherein said step of redrawing further comprises the step of:
redrawing elements of said window while said window is being dragged so that said elements are displayed in said region inside of said display area.

10. The method of claim 9, wherein said elements include a title in a title bar of said window.

11. The method of claim 9, wherein said elements include contents of said window.

12. The method of claim 9, wherein said elements include at least one scrollbar.

13. The method of claim 12, wherein said at least one scrollbar includes a scroll box, and wherein said scroll box is drawn proportional to a ratio of a size of said resized window to a size of a document.

14. A system for automatically resizing a window displayed within a display area in a graphical user interface environment, comprising:
a memory that stores the steps of a window manager program to:
detect that at least a portion of said window is being dragged between a region inside of said display area and a region outside of said display area, and
resize said window while said window is being dragged; and
a processor for executing the steps performed by the window manager program.

15. The system of claim 14, wherein the memory stores the steps of a window manager program to:
redraw said resized window so that a frame of said resized window is displayed in said region inside of said display area.

16. The system of claim 14, wherein the memory stores the steps of a window manager program to:
determine coordinates of said window;
determine coordinates of said display area;
use said window coordinates and said display area coordinates to calculate said portion of said window that is located in said region outside of said display area; and
subtract from said window said portion of said window that is located in said region outside of said display area.

17. The system of claim 14, wherein said memory stores the steps of a window manager program to:
store a current size of said window; and
restore said resized window to said stored current size after said window is dragged entirely in said inside region of said display area.

18. The system of claim 14, wherein said window manager determines when a border of said window crosses a border of said display area when detecting that at least a portion of said window is being dragged.

19. The system of claim 14, wherein said memory stores the steps of a window manager program to:
selectively inhibit said resizing step so that when said window is being dragged to said region outside of said display area, said resized window has at least a predetermined minimum size.

20. The system of claim 14, wherein said memory stores the steps of a window manager program to:
selectively inhibit said automatic window resizing for said graphical user interface environment.

21. The system of claim 14, wherein said memory stores the steps of a window manager program to:
notify applications using said window that said window is being resized.

22. The system of claim 15, wherein said memory stores the steps of a window manager program to:
redraw elements of said window while said window is being dragged so that said elements are displayed in said region inside of said display area.

23. The system of claim 22, wherein said elements include a title in a title bar of said window.

24. The system of claim 22, wherein said elements include contents of said window.

25. The system of claim 22, wherein said elements include at least one scrollbar.

26. The system of claim 25, wherein said at least one scrollbar includes a scroll box, and wherein said scroll box is drawn proportional to a ratio of a size of said resized window to a size of a document.

27. A computer-readable medium containing a window manager program that performs the steps of:
detecting that at least a portion of a window displayed within a display area in a graphical user interface environment is being dragged between a region inside of said display area and a region outside of said display area; and
resizing said window while said window is being dragged.

28. The computer-readable medium of claim 27, further including the step of:
redrawing said resized window so that a frame of said resized window is displayed in said region inside of said display area.

29. The computer-readable medium of claim 27, wherein the step of resizing comprises the steps of:
determining coordinates of said window;
determining coordinates of said display area;
using said window coordinates and said display area coordinates to calculate said portion of said window that is located in said region outside of said display area; and
subtracting from said window said portion of said window that is located in said region outside of said display area.

30. The computer-readable medium of claim 27, further comprising the steps of:
storing a current size of said window; and
restoring said resized window to said stored current size after said window is dragged entirely in said inside region of said display area.

31. The computer-readable medium of claim 27, wherein said step of detecting determines when a border of said window crosses a border of said display area.

32. The computer-readable medium of claim 27, further including the step of:
selectively inhibiting said resizing step so that when said window is being dragged to said region outside of said display area, said resized window has at least a predetermined minimum size.

33. The computer-readable medium of claim 27, wherein said automatic window resizing can be selectively inhibited for said graphical user interface environment.

34. The computer-readable medium of claim 27, wherein the step of resizing further comprises the step of:
notifying applications using said window that said window is being resized.

35. The computer-readable medium of claim 28, wherein said step of redrawing further comprises the step of:
redrawing elements of said window while said window is being dragged so that said elements are displayed in said region inside of said display area.

36. The computer-readable medium of claim 35, wherein said elements include a title in a title bar of said window.

37. The computer-readable medium of claim 35, wherein said elements include contents of said window.

38. The computer-readable medium of claim 35, wherein said elements include at least one scrollbar.

39. The computer-readable medium of claim 38, wherein said at least one scrollbar includes a scroll box, and wherein said scroll box is drawn proportional to a ratio of a size of said resized window to a size of a document.
